(19) United States
(12) Patent Application Publication
(10) Pub. No.: US 2010/0138412 A1
(43) Pub. Date: Jun. 3, 2010

(54) METHOD FOR SHOWING OBJECTS OF GEOGRAPHIC INFORMATION BY SERIATION OF DISTANCE

(76) Inventors: Ing-Kai HUANG, Hsinchu City (TW); Daryn Huang, Claremont, CA (US)

Correspondence Address: HDLS Patent & Trademark Services, P.O. BOX 220746, CHANTILLY, VA, 20153-0746, US

(21) Appl. No.: 12/325,579

(22) Filed: Dec. 1, 2008

(51) Int. Cl. G06F 17/30; G06F 7/00

(52) U.S. Cl. 707/728; 707/E17.017; 707/E17.018

(57) ABSTRACT

A method for showing objects of geographic information by seriation of distance is disclosed. A central point on an electronic map provided by a website is appointed by an user. In a specific range around the central point, at least one target object required by an user is being searched. Every individual distance between the central point and the at least one searched target object is arranged in an order in accordance with seriation of distance. Finally, the arranged results are displayed in orders on a screen for a user to easily choose a best destination.

### BACKGROUND OF THE INVENTION

1. Field of the Invention

The present invention relates to an internet search method, and more particularly, to a method for internet search using geographic information.

2. Description of Prior Art

The map is an indispensable necessity for ordinary lives. Especially, while in traveling, a person would carry a map to know unfamiliar places and where he is for saving time from losing his way.

The traditional maps are ordinarily printed and bound into as a book. Meanwhile, it is impossible to immediately update information, and the problem is that the information provided by the maps is inconsistent with the real conditions and situations. Therefore, the user would feel inconvenient in using the maps.

Therefore, as the internet becomes more and more popular, more internet companies collect geographic data and put them into on-line database. Furthermore, electronic maps, such as GoogleMape, or UrMap, combined with internet are developed and provided to users in an on-line inquiring interactive mode environment.

In a webpage of a website, a user can input a keyword or keywords for searching at least one target object. Not only the exact address of the at least one target object is being searched, but also an optimized or a shortest route to the at least one target object is planned by using the backend database.

Furthermore, this type electronic map directly fetches information from the database and shows them to the user. Therefore, it is quite convenient and fast to renew the geographic information and not to provide out-of-date information to the user without inconvenience caused by wrong information.

Right now, users input a name of an area where the at least one target object might be located in, or a keyword or keywords of the at least one target object into the electronic maps provided in the internet. After the database is fetched for obtaining the fitting name or keyword/keywords of the at least one target object in that area, the at least one target object in that area is displayed (“point” in the electronic map) as an icon or a table.

However, this traditional way to display searching result/results is not so easy for the user to understand the different individual distance between the at least one target object and him.

It is difficult for the user to select the nearest one among a lot of the target objects with the same homogeneity. Without accurate calculation, even if the user can estimate the probable distance by the naked eye, it is still possible for the user to inaccurately estimate the probable distance. And it is more difficult for the user to select the nearest one or nearer one among a group of the target objects (such as the gas stations or the banks) with the same homogeneity.

Taking the real estate companies as an example, the websites of most of the companies would provide the electronic map in which houses for user to rent or to buy are located. However, the electronic map just shows the facilities around the target houses without accurate distances and without arranging them in an order in accordance with distance. It makes that the potential buyers can not fully understand the distance relations between facilities and the target houses, and therefore, it reduces the possibility of potential buyers buying the target houses.

### SUMMARY OF THE INVENTION

The main objective of the present invention is to provide a method for showing objects of geographic information by seriation of distance. While the user searches for needed geographic information of the ate least one target object in the websites, the at least one target object is represented and arranged by seriation of distance, so it is easy for the user to understand the individual distance relations for each target object.

In order to achieve the above said objective, in the present invention, a central point on an electronic map provided by a webpage of a website is appointed by an user. In a specific range around the central point, at least one target object required by the user is being searched. The at least one searched target object is arranged in an order in accordance with each individual distance between the at least one target object and the central point. Finally, the arranged results are displayed in an order by seriation of distance on a screen for an user to easily choose a best destination.

### BRIEF DESCRIPTION OF DRAWING

FIG. 1 schematically illustrates a flowchart of a preferred embodiment of the method according to the present invention;

FIG. 2 schematically illustrates an electronic map of a preferred embodiment of the method according to the present invention; and

FIG. 3 schematically illustrates searching results by seriation of distance of a preferred embodiment of the method according to the present invention.

### DETAILED DESCRIPTION OF THE INVENTION

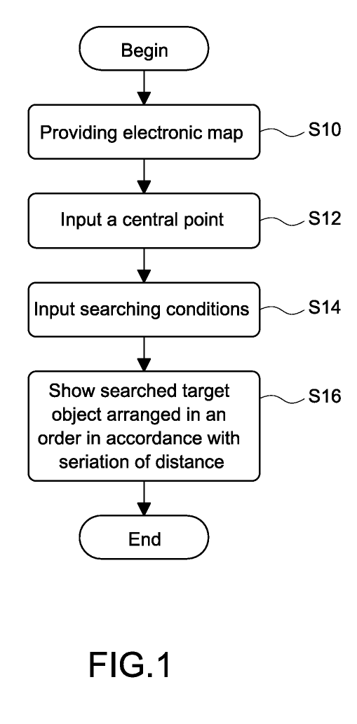

FIG. 1 schematically illustrates a flowchart of a preferred embodiment of the method according to the present invention.

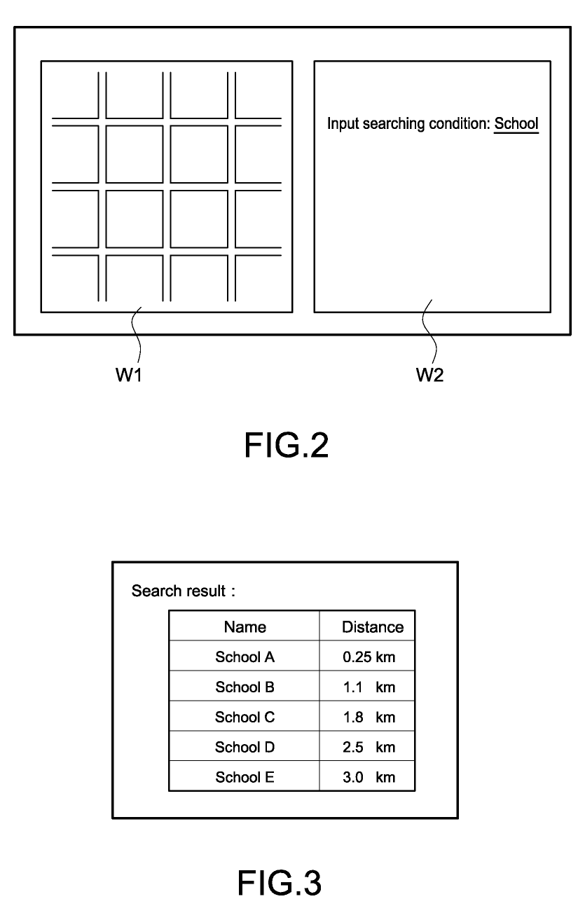

Firstly, at step S10, an electronic map is represented in the webpage and is provided to the user for operations of resizing and choosing locations and then the method proceeds to step S12. At step S12, the user can choose or input a central point on the electronic map, the operation for choosing or inputting the central point can be accomplished by using the cursor, by directly using the touch pen on the touch screen, or by inputting specific name/manes or coordinates. While the central point is chosen, the electronic map uses the central point as a center to display specific certain area around the center, such as the first window W1 shown in FIG. 2.

At step S14, the user inputs the name/names or keyword/keywords of the at least one target object, or automatically inputs the searching conditions installed by the system. As shown in the second window W2 of the FIG. 2, the electronic map searches locations of the target subjects fitting the searching conditions, and the at least one searched target object is arranged in an order in accordance with seriation of distance between the central point and the at least one searched target object and shown as display S16. As shown in FIG. 3, the seriation of distance is arranged from the near to the distant for making the user easily choose a target object as the preferred goal. The above said distance is the straight distance between two points or the shortest route.

A real estate agency website is as an embodiment for explanation. The real estate agency website provides an electronic map and lets users choose a central point, such as a location of an advance booking house, by the mouse.

Then, the user inputs the name of the at least one searching target object, for example, “school”, the system obtains all the schools around the central point and displays locations of all the schools on the electronic map.

Finally, after all the schools around the central point are obtained, by fetching the information of the database and separately calculating each individual distance between the central point and all the schools, distances displayed in a sorting table are arranged in an order in accordance with seriation of distance for making the user more easily understand.

Meanwhile, for co-operating function of route planning, each individual distance between the central point and the at least one target object can be classified as the straight distance and the shortest route to let the user have more choices but not be limited by those two.

If the invention has been described hereinafter with reference to specific embodiment, numerous variations and alternative configurations will be apparent to the man skilled in the art. Accordingly it will be apparent to the man skilled in the art that such variations and alternative configurations are also embraced by the present invention and the scope of the invention is restricted only in accordance with the accompanying claims and equivalents thereof.

What is claimed is:

1. A method for showing objects of geographic information by seriation of distance, comprising step of:
providing an electronic map;
input a central point;
input searching condition; and
displaying at least one target object being fitted with the searching conditions inside a specific range around the central point and being arranged in an order in accordance with seriation of distance between each of the at least one target object and the central point.

2. The method as claimed in claim 1, wherein the searching condition is at least one name of the at least one target object.

3. The method as claimed in claim 1, wherein the distance between each of the at least one target object and the central point is a straight line.

4. The method as claimed in claim 1, wherein the distance between each of the at least one target object and the central point is a shortest route.

5. The method as claimed in claim 1, wherein the order is from near to distant.
